(19) United States
(12) Patent Application Publication
(10) Pub. No.: US 2024/0406971 A1
(43) Pub. Date: Dec. 5, 2024

(54) METHOD AND SYSTEM FOR HANDLING INCONSISTENT RADIO LINK CONTROL STATUS REPORT

(71) Applicant: ZTE CORPORATION, Shenzhen (CN)

(72) Inventors: Fei DONG, Shenzhen (CN); He HUANG, Shenzhen (CN); Jing LIU, Shenzhen (CN)

(73) Assignee: ZTE CORPORATION, Shenzhen (CN)

(21) Appl. No.: 18/800,898

(22) Filed: Aug. 12, 2024

Related U.S. Application Data
(63) Continuation of application No. PCT/CN2022/075975, filed on Feb. 11, 2022.

(51) Int. Cl. H04W 72/231; H04L 1/1829

(52) U.S. Cl. CPC H04W 72/231; H04L 1/1835; H04L 1/1854

(57) ABSTRACT

This disclosure is directed radio link control (RLC) and media access control (MAC) protocol data unit (PDU) transmission and retransmission in wireless networks, and is particularly directed to methods and systems for preventing inconsistency in RLC transmission status reports, and for resolving such inconsistency. The disclosed solutions either proactively prevent or reduce the likelihood of the occurrence of such inconsistency at the MAC layer or provide remedial measures at the RLC layer after an inconsistent RLC report is received. The disclosed methods and systems help improving network efficiency.

### CROSS REFERENCE TO RELATED APPLICATIONS

The present application claims priority as a bypass continuation under 35 U.S.C. § 120 to International Patent Application No. PCT/CN2022/075975, titled “A METHOD AND SYSTEM FOR HANDLING INCONSISTENT RADIO LINK CONTROL STATUS REPORT,” filed Feb. 11, 2022, which is incorporated herein by reference in its entirety.

### TECHNICAL FIELD

This disclosure is directed generally to radio link control (RLC) and media access control (MAC) protocol data unit (PDU) transmission and retransmission in wireless networks, and particularly to methods and systems for preventing inconsistency in RLC transmission status reports, and for resolving such inconsistency.

### BACKGROUND

Reliable transmission and retransmission of data from a transmission end to a receiving end in the form of protocol data unit (PDU) through various network layers and interfaces is critical for any wireless communication network. To improve network resource utilization, particularly the utilization of the over-the-air radio resources, it is desirable to coordinate the various network layers such that unnecessary and wasteful transmission and/or retransmission is avoided or is at least kept at a low level.

### SUMMARY

This disclosure generally relates to radio link control (RLC) and media access control (MAC) protocol data unit (PDU) transmission and retransmission in wireless networks, and is particularly directed to methods and systems for preventing inconsistency in RLC transmission status reports, and for resolving such inconsistency.

In some implementations, a method performed by a wireless Device is disclosed. The method may include receiving, from a wireless communication node, an uplink resource grant allocated for an automatic repeat request (ARQ) process associated with a current media access control (MAC) protocol data unit (PDU) saved in an ARQ buffer of the ARQ process; retrieving a new data indicator (NDI) associated with the ARQ process to determine whether the current MAC PDU has been previously transmitted; determining a resource size of the uplink resource grant; and determining whether to ignore the uplink resource grant, flush the ARQ buffer, or replace the ARQ buffer with a new MAC PDU in response to receiving the uplink resource grant based on the NDI and/or a comparison between the resource size and a PDU size of the current MAC PDU saved in the ARQ buffer.

In the implementations above, determining whether to ignore the uplink resource grant, flush the ARQ buffer, or replace the ARQ buffer with a new MAC PDU in response to receiving the uplink resource grant may include in response to determining that the NDI is toggled, replacing the current MAC PDU in the ARQ buffer with a new MAC PDU and transmitting the new MAC PDU using the received uplink resource grant.

In any of the implementations above, determining whether to ignore the uplink resource grant, flush the ARQ buffer, or replace the ARQ buffer with the new MAC PDU in response to receiving the uplink resource grant based on the NDI and/or a comparison between the resource size and a PDU size of the current MAC PDU saved in the ARQ buffer may include: in response to determining that the NDI is not toggled and determining that the resource size of the uplink resource grant matches the size of the current MAC PDU saved in the ARQ buffer, retransmitting the current MAC PDU saved in the ARQ buffer.

In some of the implementations above, determining whether to ignore the uplink resource grant, flush the ARQ buffer, or replace the ARQ buffer with the new MAC PDU in response to receiving the uplink resource grant based on the NDI and/or a comparison between the resource size and a PDU size of the current MAC PDU saved in the ARQ buffer may include: in response to determining that the NDI is not toggled and determining that the resource size of the uplink resource grant does not match the size of the current MAC PDU saved in the ARQ buffer, discarding the uplink resource grant.

In some of the implementations above, determining whether to ignore the uplink resource grant, flush the ARQ buffer, or replace the ARQ buffer with the new MAC PDU in response to receiving the uplink resource grant based on the NDI and/or a comparison between the resource size and a PDU size of the current MAC PDU saved in the ARQ buffer may include: in response to determining that the NDI is not toggled and determining that the resource size of the uplink resource grant does not match the size of the current MAC PDU saved in the ARQ buffer, flushing the ARQ buffer.

In some of the implementations above, determining whether to ignore the uplink resource grant, flush the ARQ buffer, or replace the ARQ buffer with the new MAC PDU in response to receiving the uplink resource grant based on the NDI and/or a comparison between the resource size and a PDU size of the current MAC PDU saved in the ARQ buffer may include: in response to determining that the NDI is not toggled and determining that the resource size of the uplink resource grant does not match the size of the current MAC PDU saved in the ARQ buffer, replacing the current MAC PDU in the ARQ buffer with a new MAC PDU and transmitting the new MAC PDU using the received uplink resource grant.

In some other implementations, a method performed by a wireless device is disclosed. The method may include retransmitting a current MAC PDU to a wireless communication network node; and using an ARQ timer associated with an ARQ process corresponding to the transmitted current MAC PDU to control retransmission of the current MAC PDU.

In the implementations above, the ARQ timer comprises a buffer flush timer for an ARQ buffer of the ARQ process; and using the ARQ timer to control the retransmission of the current MAC PDU may include: starting or restarting the buffer flush timer when the last symbol of the current MAC PDU is transmitted; and in response to an expiration of the buffer flush timer, flushing the ARQ buffer.

In some of the implementations above, the ARQ timer comprises an ARQ retransmission timer; and using the ARQ timer to control the retransmission of the current MAC PDU comprises in response to determining that an uplink resource grant for the ARQ process associated with the current MAC PDU is received from the wireless communication network node: determining whether the ARQ retransmission timer is configured and running; and in response to determining that the ARQ retransmission timer is configured and running, determining whether to retransmit the current MAC PDU or transmit a new MAC PDU using the uplink resource grant.

In some of the implementations above, determining whether to retransmit the current MAC PDU or transmit a new MAC PDU using the uplink resource grant may include: in response to an NDI of the ARQ process being toggled, using the uplink resource grant to transmit the new MAC PDU; and in response to the NDI of the ARQ process not being toggled, using the uplink resource grant to retransmit the current MAC PDU.

In some of the implementations above, the method may further include: in response to determining that the ARQ retransmission timer is configured but not running, using the uplink resource grant to transmit the new MAC PDU regardless of a value of the NDI.

In some other implementations, another method performed by a wireless device is disclosed. The method may include configuring at least one ARQ process for retransmission of MAC PDUs associated with a serving cell for the wireless device serviced by a wireless network node; receiving an ARQ control message from the wireless network node; and controlling the at least one ARQ process according the ARQ control message.

In the implementations above, the ARQ control message comprises a MAC control element (CE) or a downlink control information (DCI) message.

In some of the implementations above, the ARQ control message comprises an ARQ buffer flush MAC CE or DCI for one or more of the at least one ARQ process associated with the serving cell; and controlling the at least one ARQ process according the ARQ control message may include flushing ARQ buffer for the one or more of the at least one ARQ process in response to receiving the ARQ control message.

In some of the implementations above, the ARQ control message comprises an ARQ buffer flush MAC CE, the ARQ buffer flush MAC CE may include an ID for the serving cell and one or more flushing indicator fields corresponding to one or more ARQ process IDs.

In some of the implementations above, the ARQ control message comprises an ARQ synchronization MAC CE or DCI for an ARQ process of the at least one ARQ process associated with the serving cell; and the method further may include configuring an NDI value of the ARQ process according an NDI indication included in the ARQ control message.

In some of the implementations above, the ARQ control message comprises the ARQ synchronization MAC CE, the ARQ synchronization MAC CE including an ID of the serving cell and/or a plurality of indicator filed for indicating ARQ process IDs for NDI value configuration.

In some of the implementations above, the ARQ control message comprises the ARQ synchronization MAC CE, the ARQ synchronization MAC CE including a plurality of indicator fields for indicating serving cells for NDI value configuration.

In some of the implementations above, the ARQ control message may include an ARQ synchronization MAC CE or DCI for the at least one ARQ process associated with the serving cell; and configuring an NDI value of the at least one ARQ process according an NDI indication included in the ARQ control message.

In some other implementations, another method performed by a transmitting RLC entity of a wireless device is disclosed. The method may include receiving, from a receiving RLC entity of a wireless communication node corresponding to the transmitting RLC entity, an RLC-received status report; extracting a range of sequence number (SN) for RLC data PDUs as determined by the wireless communication node as having been transmitted by the wireless device; and in response to determining that at least one RLC data PDU sequence number within the range of sequence number has not yet been transmitted by the wireless device, transmitting an RLC control PDU to the wireless communication node to indicate that the RLC-received status has an invalid sequence number range for RLC data PDUs transmitted by the wireless device.

In the implementations above, the RLC control PDU comprises an indication of the highest sequence number for RLC data PDUs that have been transmitted.

In some other implementations, a wireless device comprising a processor and a memory is disclosed. The processor may be configured to read computer code from the memory to implement any of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network comprising a wireless access network, a core network, and data networks.

FIG. 2 illustrates and example wireless access network including a plurality of mobile stations and a wireless access network node in communication with one another via an over-the-air communication interface.

FIG. 3 illustrates an example diagram for communication of PDUs between a transmitting end and a receiving end through various network layer entities and via an over-the-air radio interface.

FIG. 4 illustrates an example MAC entity.

FIG. 5 illustrates example rolling windows for monitor receipt of sequenced PDUs by an acknowledgement mode (AM) RLC entity in a receiving network node or device.

FIG. 6 illustrates an example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 7 illustrates another example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 8 illustrates another example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 9 illustrates another example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 10 illustrates another example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 11 illustrates an example MAC control element (CE) that may be used in the implementation of FIG. 10.

FIG. 12 illustrates another example PDU transmission/retransmission processing flow implemented by a transmitting MAC entity of a transmitting network device for reducing a likelihood of resulting in an inconsistent RLC status report by a receiving RLC entity of a corresponding receiving network device.

FIG. 13 illustrates example MAC CEs that may be used in the implementation of FIG. 12.

FIG. 14 illustrates an example processing flow implemented by a transmitting RLC entity of a transmitting network device for handling an inconsistent RLC status report received from a corresponding receiving RLC entity of a receiving network device.

FIG. 15 illustrates and example RLC control PDU transmitted by the transmitting RLC entity to the receiving RC Lenity when detecting inconsistent RLC status report in FIG. 14.

FIG. 16 illustrates an example processing flow implemented by a transmitting RLC entity of a transmitting network device for handling an inconsistent RLC status report received from a corresponding receiving RLC entity of a receiving network device

### DETAILED DESCRIPTION

The technology and examples of implementations and/or embodiments described in this disclosure can be used to facilitate over-the-air radio resource allocation, configuration, and signaling in wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed radio link control (RLC) and media access control (MAC) protocol data unit (PDU) transmission and retransmission in wireless networks, and is particularly directed to methods and systems for preventing inconsistency in RLC transmission status reports, and for resolving such inconsistency. The disclosed solutions either proactively prevent or reduce the likelihood of the occurrence of such inconsistency at the MAC layer or provide remedial measures at the RLC layer after an inconsistent RLC report is received.

### Wireless Network Overview

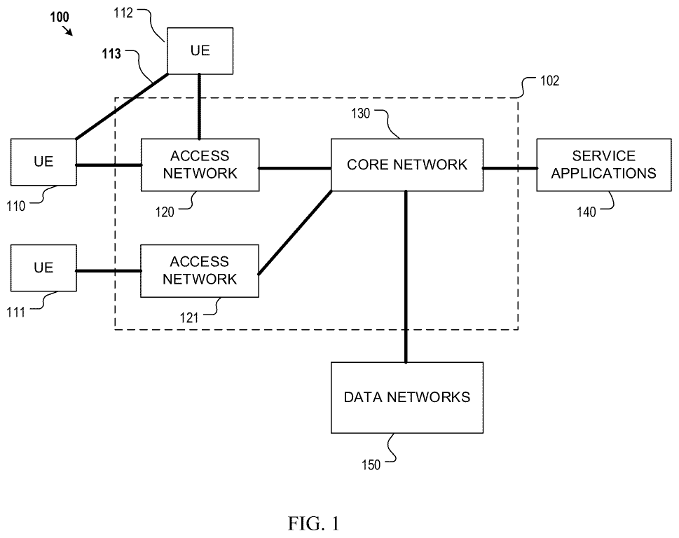

An example wireless communication network, shown as 100 in FIG. 1, may include user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The Access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

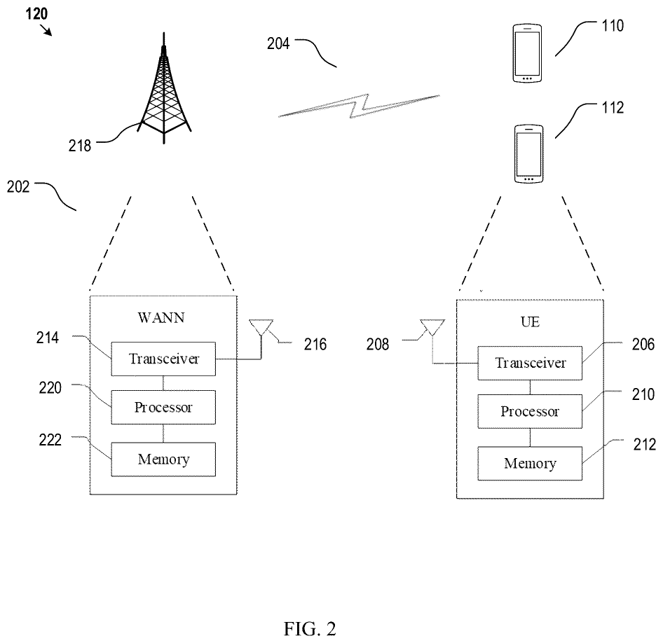

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the processor 220, cause the processor 220 to implement various functions of the WANN 120 described herein.

### Protocol Data Unit (PDU) Transmission and Retransmission

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

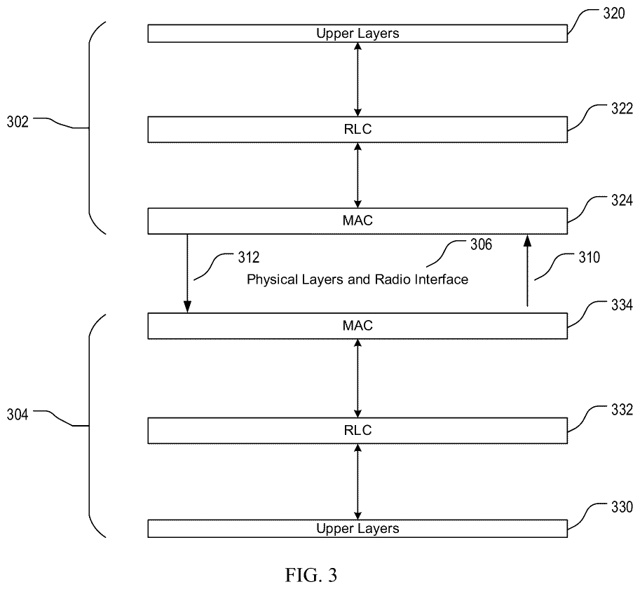

FIG. 3 illustrates a simplified view of the various network layers involved in transmitting user-plane PDUs from a transmitting device 302 to a receiving device 304 in the example wireless access network of FIG. 2. FIG. 3 is not intended to be inclusive of all essential device components or network layers for handling the transmission of the PDUs. FIG. 3 illustrates that the data packaged by upper network layers 320 at the transmitting device 302 may be transmitted to corresponding upper layer 330 at the receiving device 304 via intermediate RLC layer 322 of the transmitting device, the physical layers of the transmitting and receiving devices and the radio interface, as shown as 306, and the MAC layer 334 and RLC layer 332 of the receiving device. Various network entities in each of these layers may be configured to handle the transmission and, as described in further detail below, retransmission of the PDUs.

Various transmission mode may be implemented. For example, the transmission of the PDUs from the transmitting device to the receiving device may be performed in acknowledged mode (AM), unacknowledged mode (UM), and transparent mode (TM). Depending on the mode, RLC entities of different functionalities may be configured for handling transmission in corresponding modes. An AM RLC entity, may be established for handling transmission of PDUs in acknowledged mode, for receiving and processing acknowledgment message/report from corresponding receiving AM RLC entity in the receiving device, and for working with the MAC layer to perform retransmission of the PDUs when needed. The disclosure below is particularly provided in the context of transmission and retransmission of PDUs in the AM mode.

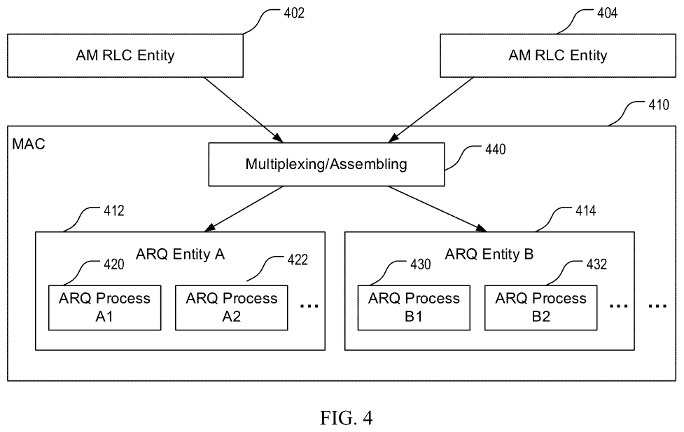

As further shown in FIG. 4, the RLC layer 322 of the transmitting device 302 may thus be configure with one or more AM RLC entities 402 and 404 to monitor and manage data transmission and retransmission from the transmitting device 302 at the radio link control level. Each AM RLC entity, for example, may be established for a particular radio bearer assigned to a communication session. The AM RLC entity receives RLC service data units (SDUs) from the upper layers 320 and generates RLC PDUs. These RLC PDUs may then be handled by a MAC entity 410. The MAC entity 410 may manage multiplexing and assembling the RLC PDUS into MAC PDUS for transmission, as shown by 440. The MAC entity 410 may be configured with one or more automatic retransmission request (ARQ) entities denoted as ARQ entity A and ARQ entity B and shown as 412 and 414 in FIG. 4. These ARQ entities, for example, may be implemented specifically as hybrid ARQ (HARQ) entities for handle HARQ retransmission. Each ARQ entities may be configured with one or more ARQ processes as parallel resources for handling PDU transmission/retransmission at the MAC level. For example, the ARQ entity A 412 may further include one or more ARQ processes shown as 420 and 422 whereas the ARQ entity 414 may include one or more ARQ processes shown as 430 and 432. Each of the ARQ processes 420, 422, 430, and 432 may be allocated with resources for handling transmission/retransmission of one MAC PDU at a time.

The resources associated with an ARQ or HARQ process (hereinafter collectively referred to as ARQ process) may include, for example, an ARQ buffer for saving a MAC PDU for transmission and potential retransmission when needed. The ARQ buffer in turn may be associated with a new data indicator (NDI) for indicating whether the received uplink (UL) resource grant is for new transmission. If it is toggled, indicating that the UL resource grant is for new transmission, a new MAC PDU shall be generated and replace the current MAC PDU saved in the ARQ buffer and then be transmitted using the received UL resource grant. If it is not toggled, indicating that the UL resource grant is for re-transmission, the PDU saved in the ARQ buffer shall be re-transmitted using the received UL grant. The NDI may be set to toggled when the ARQ buffer is filled with PDU that is yet to be transmitted, and un-toggled when the PDU is transmitted awaiting potential retransmission.

The receiving ARQ processes, ARQ entities, MAC entity, and RLC entities in the receiving device may be configured similarly. The corresponding pair of transmitting/receiving entities or processes may be configured as peers for collaboratively handling the various aspect of the transmission and retransmission of the PDUs in the AM mode from the transmitting device to the receiving device.

The AM RLC entities may be configured to manage the RLC PDUs in sequences. The PDUs may be assigned with ordered PDU sequence number (SN). The SN space may be predefined. For example, the SN may be defined as an N-bit number, ranging from 0 to 2^{N}−1. The number N, for example, may be configured as 18 or any other number. As such, the SN number may range from 0 to 262143 for 18-bit SN space. The SN number may be cyclically reused. In other words, the next sequence number after 2^{N}−1 (e.g., 262143) would become 0. The SN number may also be represented in a different space transformed from 0 to 2^{N}−1.

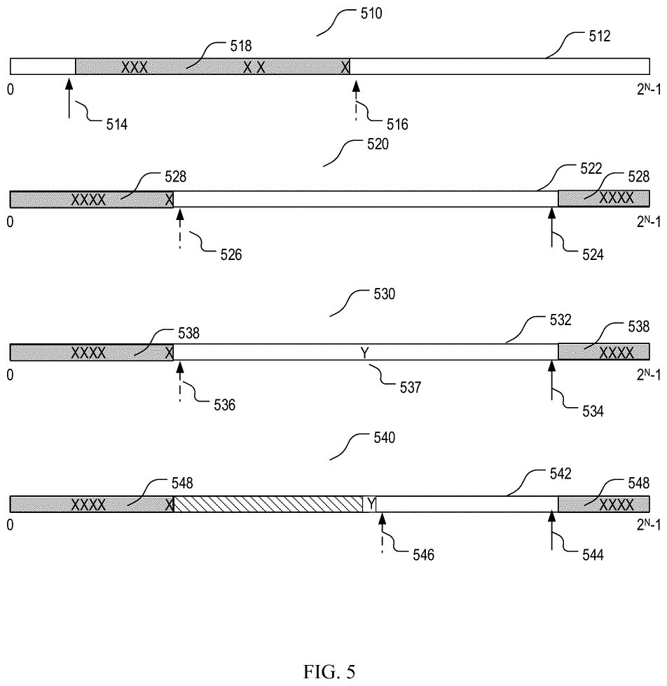

On the side of receiving device 302, the receiving AM RLC entities may monitor received RLC PDUs by their sequence numbers, thereby keeping track of receiving status of the RLC PDUs. For example, the receiving RLC entity (or entities) may use a rolling active receiving window to monitor such status, as shown in more detail in FIG. 5.

In FIG. 5, the RLC PDU sequence number space of 0-2^{N}−1 is represented by the bars 512, 522, 532, and 542 under different scenarios 510, 520, 530, and 540 that are descried in more detail below. The receiving RLC entity may use a pair of pointers, shown as 514/516, 524/526, 534/536, and 544/546 for scenarios 510, 520, 530, and 540, respectively, to demarcate an active RLC PDU receiving window (the shaded portions of the RLC PDU sequence space, as indicated by 518, 528, 538, and 548). The active window represents PDU sequence number range that the receiving RLC entity considers, based on receipt of RLC PDUs, as having been transmitted by the transmitting RLC entity. The “X” within the active receiving window 518, 528, 538 or 548 represents sequence numbers of RLC PDUs that have been actually received by the receiving RLC entity. PDUs corresponding to unmarked sequence numbers within the active receiving window may be considered by the receiving RLC entity as being transmitted already but not yet received.

As such, the pointer 514, 524, 534, or 544, denoted as RX_NEXT, may represent the lowest sequence number of a corresponding RLC PDU that has not been received (all PDU with sequences before this PDU have been received). The pointer 516, 526, 536, or 546, denoted as RX_HIGHEST, may represent the next sequence number to the highest one that the corresponding RLC PDU has been received by the receiving RLC entity. In other words, the receiving RLC entity monitors the active receiving window by moving the RX_NEXT pointer to the next PDU sequence number when all lower PDUs are received, and advancing the RX_HIGHEST pointer to the next of the highest received PDU sequence number. When the PDU within the window is received, they are marked. The RX_NEXT pointer advances as the lower end portion of the active receiving window is being marked. Because the RLC PDU sequence space 512, 522, 532, or 542 cycles, the active receiving window may wrap around as shown in the scenarios 520, 532, and 540.

The pair of pointers (RX_NEXT, RX_HIGHEST) indicating the current active receiving window as considered by the receiving RLC entity may be included in an RLC status report and communicated to the peer transmitting RLC entity. The report may be communicated periodically, or at predefined times, or being triggered by redefined events.

Under normal circumstances, the transmitting MAC entity may transmit the MAC PDUs corresponding to the RLC PDUs in sequence, stale PDUs saved in the ARQ buffer would be refreshed with new PDUs and the corresponding NDI (i.e., new data indication) value would be updated as the transmission and retransmission of the sequence of PDUs advance. However, in some circumstances, the MAC entity may fail to refresh ARQ buffer of some ARQ processes, those PDUs may be stale. As such, the SN number corresponding to the stale PDU would become overdue. Yet the MAC entity, due to lack of information, may nevertheless decide to transmit the stale PDU. In some situations, as illustrated in scenario 530 of FIG. 5, the transmitted PDU with RLC sequence number 537 indicated as Y may be received by the receiving RLC entity. Even though this received PDU is stale, its sequence number 537 may apparently be ahead of the previous RX_HIGHEST pointer 536. The receiving RLC entity thus may advance the RX_HIGHEST pointer from 536 to the next sequence number of 537, as shown further by 546 in scenario 540. An RLC status report thus may be generated at some time point, indicating to the transmitting RLC entity that the active receiving window is between 534 (or 544) and next to 537 (or 546). The transmitting RLC entity would then be at a dilemma because the PDUs having sequence numbers between 536 and 546, inclusive, has not yet been transmitted, yet the receiving RLC apparently indicates that the PDU with sequence number 537 has been received, thereby leading to uncertain behavior of the transmitting device.

As a specific example, the cyclic SN allocation is may range from 0˜262143, if one transmitting RLC SDU to the MAC entity is allocated with an SN number of 262143, then the next RLC SDU will wrap around to the SN number of 0, so that the status report window with a range from RX_NEXT and RX_HIGHEST is also a cyclic window. As one example, the SN range for the receiving window in the status report may be {262140, 5000}. However, this cyclic arrangement may lead to an uncertainty behavior by the transmitting device when an overdue SN is received from the MAC layer. For example, if the receiving RLC entity receives from lower layer an RLC PDU with an SN=9000 which have been overdue for a certain time (e.g., this PDU was actually assigned in the previous SN allocation round) and the current status report range is {262140, 5000}, then the receiving RLC entity would advance the status report range to {262140,9001}. However, at the transmitting RLC peer entity, the RLC PDUs with a SN range {5000, 9001} have not yet been transmitted.

Various embodiments and implementations below are provided to resolve this dilemma for the transmitting RLC entity and avoid uncertain behavior, either by preventive measures on the part of the transmitting RLC entity, by preventive corporation between the transmitting RLC entity and the receiving RLC entity, or by remedial actions by the transmitting RLC entity upon receiving the RLC status report containing active receiving window that is inconsistent with the record and information at the transmitting RLC entity. These example embodiments are either implemented at the MAC layer or at the RLC layer.

### MAC-Based Implementation

These example implementations may be generally based on timely flushing the ARQ buffer at the MAC layer of the transmission device. Essentially, considering that the most likely reason why the receiving RLC entity may receive an RLC PDU with an overdue SN (and thereby generating an inconsistent RLC status report) is that the overdue RLC PDU have been saved in the transmitted ARQ buffer and was not timely flushed, and was somehow transmitted to the receiving RLC entity after a certain time, these implementations generally aim at preventing or reducing the likelihood of a transmission of the PDU with overdue SN at the transmitting MAC layer in the first place.

In some example implementations, where the transmitting device is a user equipment (UE) or terminal device and the receiving device is a base station, the UE and the base station may coordinate certain actions in order to prevent or reduce the likelihood of transmission of the PDU with overdue SN. In such example situation, the transmission of RLC PDU would be an uplink (UL) transmission. The base station, may allocate a UL resource grant corresponding to an ARQ process intended for retransmission by the MAC entity of the UE. The UE may determine whether to ignore the UL resource grant and/or flush the ARQ buffer or replace the ARQ buffer with a new MAC PDU in response to receiving the UL resource grant based on the NDI associated with ARQ process and/or a comparison between the resource size and a PDU size of the current MAC PDU saved in the ARQ buffer.

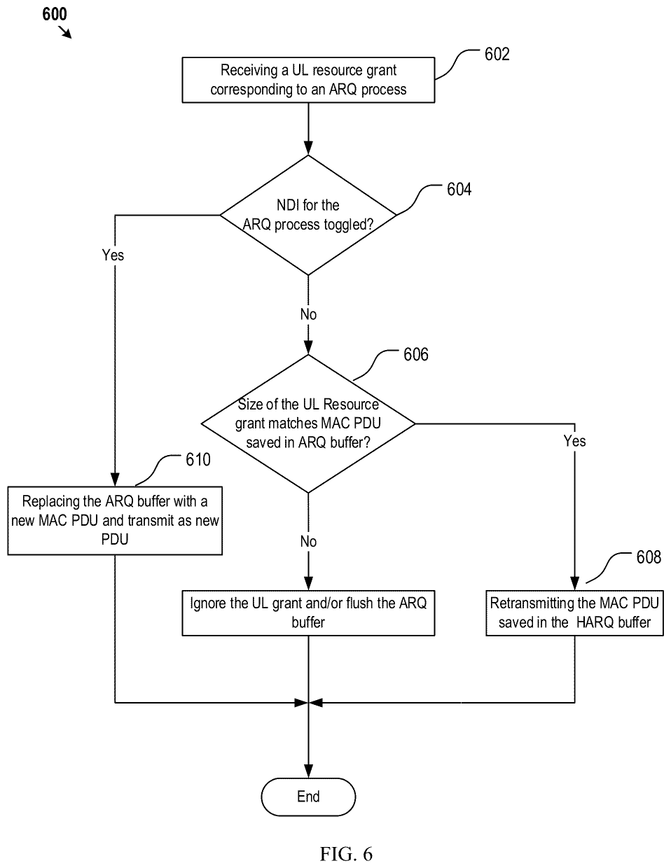

An example processing flow at the UE is illustrated as 600 in FIG. 6. At 602, of FIG. 6, the UE may receive a UL resource grant corresponding to a particular ARQ process in the MAC layer. The ARQ process may be indicated by an ARQ ID in the UL source grant. The resource grant may at least include a size of the resource granted for the uplink transmission of the PDU saved in the ARQ buffer associated with the particular ARQ process.

At 604, the MAC entity at the UE determines whether the NDI associated with the particular ARQ process is toggled or not. If the MAC entity determines that the NDI is toggled, indicating that the UL resource grant is for a new transmission, the MAC entity proceed to replacing the current MAC PDU saved in the ARQ buffer with a new MAC PDU and then send it as a new transmission using the received UL resource grant, as shown by 610. Otherwise, as shown by 606, the MAC entity of the UE further determines whether a size of the received UL resource grant matches the size of the MAC PDU currently saved in the ARQ buffer corresponding to the particular ARQ process. If the sizes match, the MAC entity may conclude that the currently saved MAC PDU in the ARQ buffer still needs retransmission and may then proceed to retransmitting the MAC PDU using the received UL resource grant, as shown by 608. Otherwise, the MAC entity may consider the MAC PDU currently saved in the ARQ buffer as associated with an overdue SN, and thus proceed to ignoring the received UL resource grant and/or flushing the ARQ buffer corresponding to the particular ARQ process.

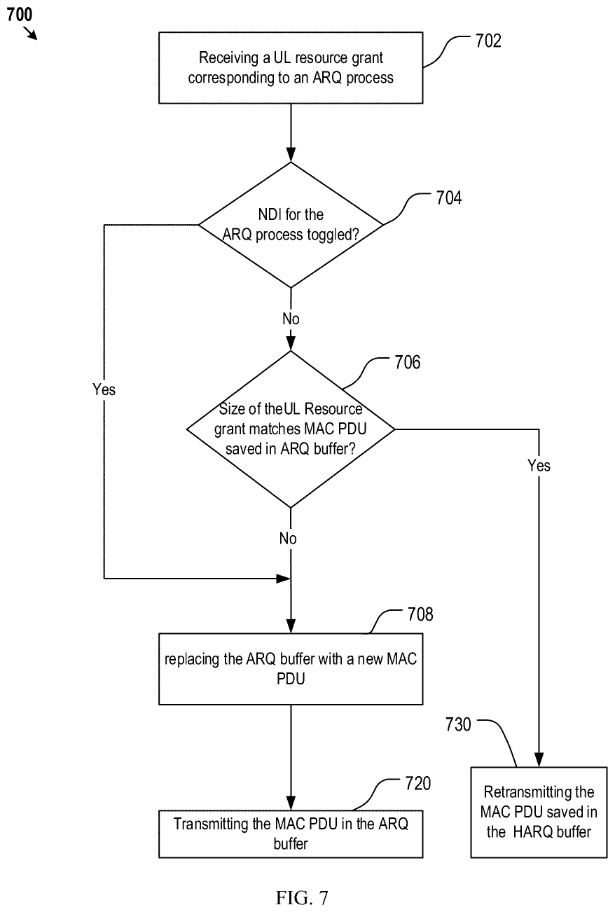

Another alternative implementation is illustrated by the flow 700 of FIG. 7. In the flow 700 of FIG. 7, at 702, similar to 602 of FIG. 6, the UE may receive a UL resource grant corresponding to a particular ARQ process in the MAC layer. The ARQ process may be indicated by an ARQ ID in the UL resource grant. The resource grant may at least include a size of the resource granted for the uplink transmission of the PDU saved in the ARQ buffer associated with the particular ARQ process. At 704, similar to 604 of FIG. 6, the MAC entity at the UE determines whether the NDI associated with the particular ARQ process is toggled or not. If the MAC entity determines that the NDI value is toggled (i.e., the value is changed from 1 to 0, vice versa), indicating that the UL resource grant is for a new transmission, the MAC entity proceeds to replacing the current MAC PDU saved in the ARQ buffer with a new MAC PDU and then send it as a new transmission using the received UL resource grant, as shown by the branch from 704 to 708 followed by 720 . . . . Otherwise, as shown by 706, the MAC entity of the UE further determines whether a size of the received UL resource grant matches the size of the MAC PDU currently saved in the ARQ buffer corresponding to the particular ARQ process. If the sizes match, the MAC entity may conclude that the currently saved MAC PDU in the ARQ buffer still needs retransmission and proceed to retransmitting the MAC PDU using the received UL resource grant, as shown by the “yes” branch from 706 to 730. Otherwise, the MAC entity may consider the MAC PDU currently saved in the ARQ buffer as associated with an overdue SN. However, instead of ignoring the received UL resource grant and merely flush the ARQ buffer corresponding to the particular ARQ process when there is a mismatched sizes, the MAC entity may use the received UL grant for transmitting a new MAC PDU. In particular, the MAC entity may replace the current MAC PDU in ARQ buffer associated with the particular ARQ process with a new MAD PDU, as shown by the branch from 706 to 708, and proceed to transmitting the new MAC PDU using the received UL resource grant, as shown by 720.

In some other implementations, the MAC entity at the transmitting device may perform an ARQ buffer flush procedure without considering network side (base station) resource grant. Rather, various ARQ timer may be configured and used to provision the flushing of the ARQ buffer.

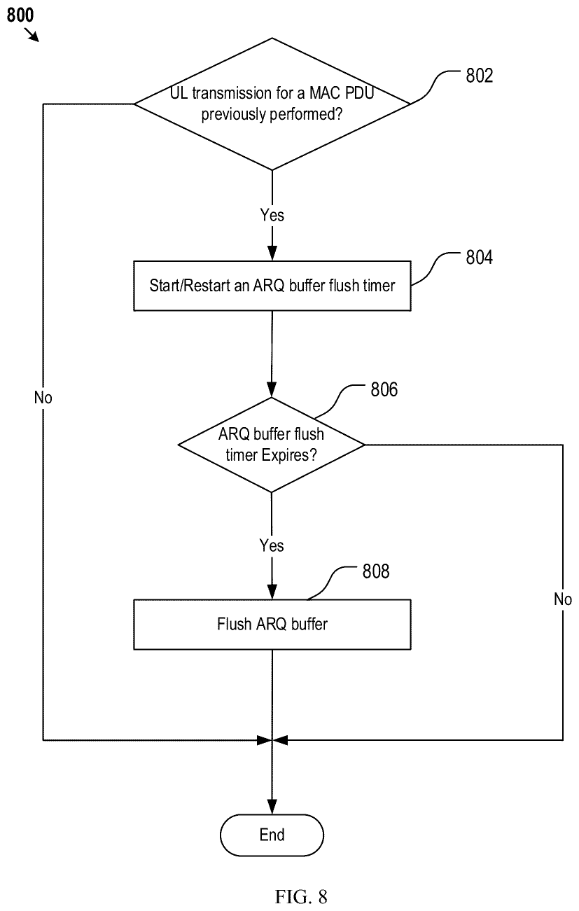

An example processing flow 800 of an implementation based on an ARQ buffer flushing timer is illustrated in FIG. 8. Specifically, at 802, the transmitting MAC entity determines whether a transmission of a MAC PDU for a particular ARQ process has been performed or not. The particular ARQ may be identified by an ARQ process ID. If it is determined that the UL transmission of the MAC PDU has not been performed, the process ends. Otherwise, as shown by 804, the receiving MAC entity may start or restart an ARQ buffer flush timer at the last symbol of the transmission of the current MAC PDU. The ARQ buffer flush timer may be configured with a predetermined start time value. In 806, the receiving MAC entity monitors whether the ARQ buffer flush timer expires or not. When the ARQ buffer flush timer expires, the receiving MAC entity flushes the ARQ buffer associated with the particular ARQ process, as shown by 808, regardless of whether the current MAC PDU has been retransmitted or not. In such a manner, the ARQ buffer is forced to timely flush, preventing it from storing MAC PDU with overdue SN.

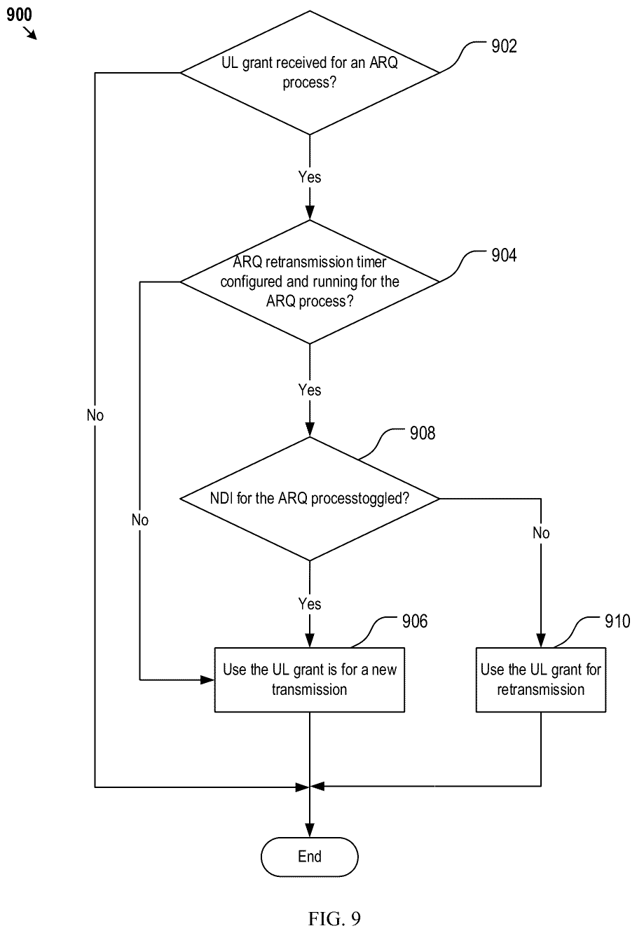

Another example processing flow 900 of an implementation based on an ARQ retransmission timer is illustrated in FIG. 9. The transmission device may be a UE and the receiving device may be a base station. The transmission of the MAC PDU may be an uplink transmission. Specifically, at 902, UE MAC entity may determine whether a UL resource grant is received for a particular ARQ process. The particular ARQ process may be identified by an ARQ process ID. If it is determined that a UL resource grant for the particular ARQ process is not received, the process 800 ends. Otherwise, the UE MAC entity may further determine whether an ARQ retransmission timer is configured and running for the particular ARQ process, as shown by 904. If it is determined that ARQ retransmission timer is configured but not running, the UE MAC entity may then use the received UL resource grant for a new transmission of a new MAC PDU regardless of the NDI value, as shown by 906. If it is determined that ARQ retransmission timer is configured and running, the UE MAC entity further determines whether the NDI for the particular ARQ process is toggled or not, as shown by 908. If it is toggled, the UE MAC entity uses the received UL resource grant for a new transmission of a new MAC PDU, as shown by 906. Otherwise, the UE MAC entity uses the received UL resource grant to perform retransmission of the MAC PDU currently saved in the ARQ buffer corresponding to the particular ARQ process, as shown by 910. In such a manner, the MAC PDU saved in the ARQ buffer would be either timely retransmitted or replaced with new MAC PDU for new transmission relying on an ARQ retransmission timer.

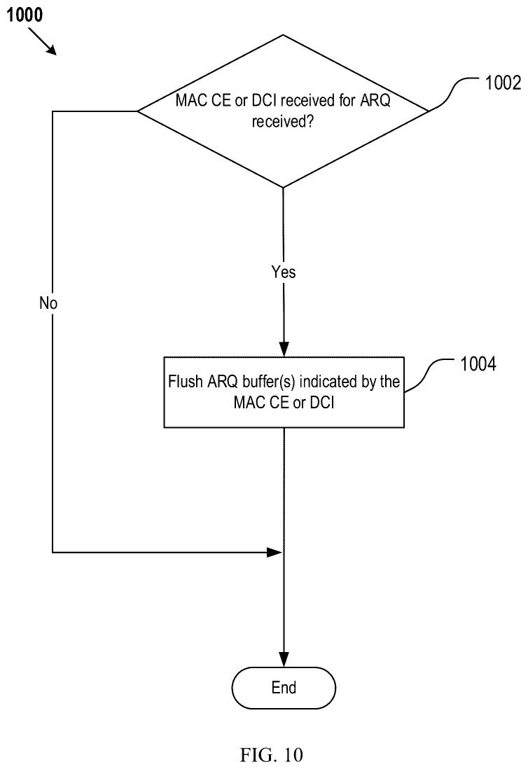

In some other example implementations, timely flushing of the ARQ buffer of a particular ARQ process may be signaled via, for example, a MAC control element (CE) or a downlink control information (DCI) message. An example processing flow is illustrated as 1000 in FIG. 10. Specifically, in the flow 1000, at 1002, the receiving device determines whether a MAC CE or a DCI message for buffer flushing of a particular ARQ process is received. The particular ARQ process may be identified by an ARQ process ID. If such a MAC CE or DCI message is received, the receiving MAC entity proceeds to flushing the ARQ buffer associated with the particular ARQ process indicated by the MAC CE or DCI message, as shown by 1004. Otherwise, the process 1000 ends. Alternatively, the MAC CE or DCI may be associated with flushing of buffers of ARQ processes associated with a serving cell. As such, upon receiving such MAC CE or DCI, the receiving MAC entity may proceed to flushing all ARQ buffers associated with all ARQ processes corresponding to the indicated serving cell.

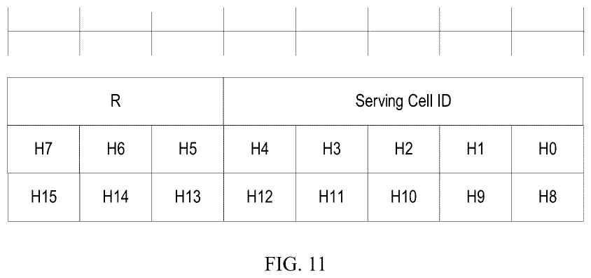

FIG. 11 shows an example MAC CE that may be used for the implementation of FIG. 10. This example MAC CE may include a serving cell ID for indicating the serving cell of which the ARQ process buffers for one or more indicated ARQ process IDs are to be flushed. The one or more indicated ARQ process IDs may be implemented as flag fields, for example, H0-H15 of FIG. 11. Specifically, H0 may be used as a flag to indicate whether the ARQ process with ID=0 with respect to the indicated serving cell is to be flushed. H1 may be used as a flag to indicate whether the ARQ process with ID=1 with respect to the indicated serving cell is to be flushed, and so on.

Likewise, an example DCI for indicating flushing of ARQ buffers in the implementation of FIG. 10 above, In the DCI, it may include at least one of the following information:
1: Serving Cell ID
2: ARQ process ID information for flushing, e.g., a bitmap which is used for mapping ARQ process IDs for which the ARQ buffers to be flushed or one codepoint to indicate the ARQ process IDs for which the HARQ buffer to be flushed.

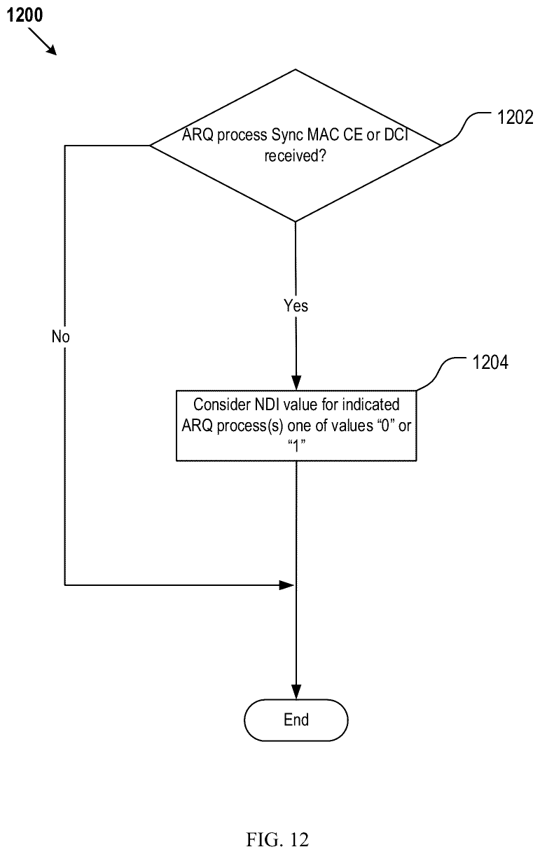

In some other implementations, timely flushing of the ARQ buffer of a particular ARQ process may be based on a synchronization MAC CE or a DCI message. An example processing flow is illustrated as 1200 in FIG. 12. Specifically, in the flow 1200, at 1202, the receiving device determines whether an ARQ process synchronization MAC CE or a DCI message is received. If such a MAC CE or DCI message is not received, the process 1200 ends (the NDI values for would be kept as is). Otherwise, the receiving MAC proceeds to considering the NDI value for the ARQ process or processes indicated by MAC CE/DCI as one of ‘1’ or ‘0’, as shown by 1204. By setting the NDI values in such a manner, the maintained NDI values between NW side and UE side can be synchronized.

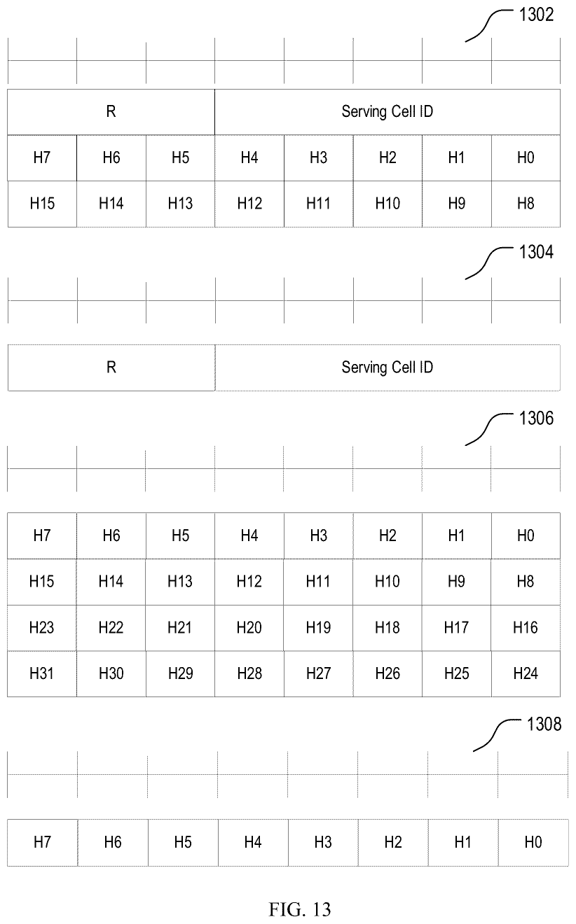

One or more ARQ processes may be indicated by the MAC CE or DCI in various manners. FIG. 13 shows example MAC CEs 1302, 1304, and 1306 that may be used for the implementation of FIG. 12. The example MAC CE 1302 may include a serving cell ID for indicating the serving cell where the NDI value for the indicated ARQ process IDs are set to ‘1’ or ‘0’. The Hi fields may be further used to indicate whether the NDI shall be set to “1” or “0”. For example, if Hi=1, the NDI value for ARQ process ID=i shall be set to ‘1’ or ‘0’; otherwise the NDI value for the ARQ process ID=0 shall be kept as it is.

The example MAC CE 1304 may include a serving cell ID for indicating the serving cell where the NDI values for ARQ buffer of the indicated serving cell are set to ‘1’ or ‘0’. The MAC CE 1304 may not need to additionally indicate specific ARQ process ID as NDIs of all ARQ processes associated with the indicates serving cell ID are to be set to value “1” or “0” in this particular implementation.

The example MAC CEs 1306 and 1308 may include multiple fields Hi each associated with a serving cell. For this MAC CE, Hi=1 may indicate that the NDI values for all ARQ processes in serving cell i shall be set to ‘1’ or ‘0’, otherwise, they shall be kept as it is.

### Handling of Inconsistent RLC Status Report at RLC Layer

In some implementations, the transmitting device may perform a set of remedial actions when receiving an RLC status report from a corresponding receiving device that is inconsistent with the information at the transmitting device.

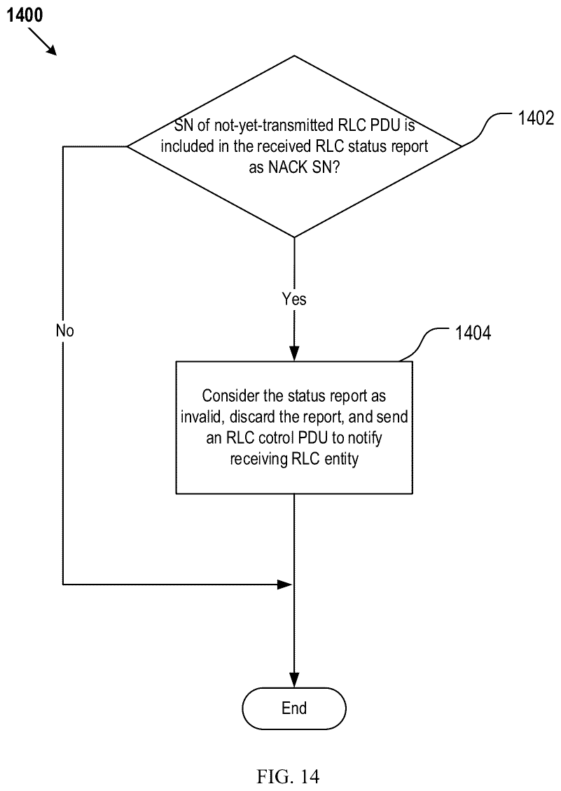

An example processing flow at the transmitting device is illustrates by 1400 of FIG. 14. At 1402, the transmitting device determines whether an SN of not-yet transmitted RLC PDU is included the received RLC status report from the corresponding receiving device as NACK SN. In other words, the transmitting device determines whether the RLC status report is inconsistent with the transmission information known at the transmitting device. If there is no inconsistency not only for the status report but also for any other kinds of inconsistency, the process ends. Otherwise, the transmitting device considers the status report as invalid, may discard it and send an RLC control PDU to inform the peer receiving AM RLC entity about the inconsistency, as shown by 1404.

In some implementations, the RLC control PDU above may be used for one AM RLC entity which has received the status report to inform the peer AM RLC entity about the invalidation of the status report.

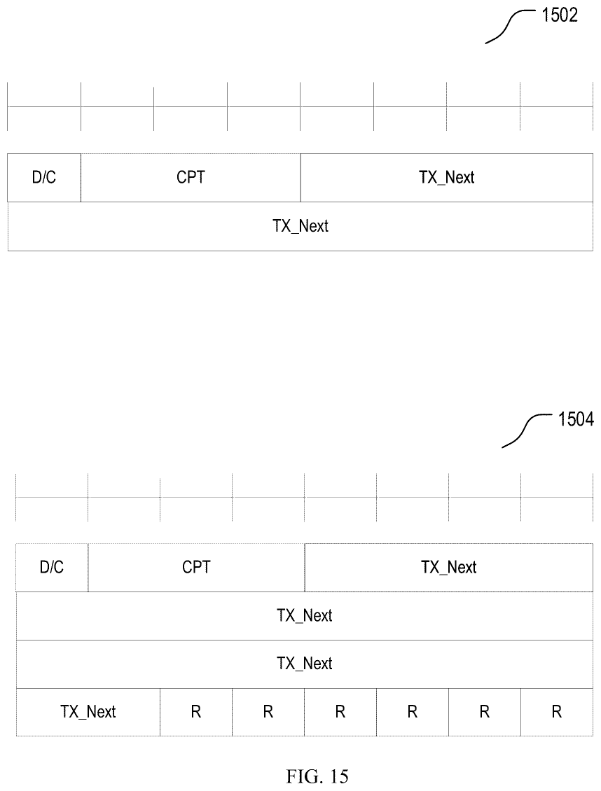

In some implementations, the transmitting AM RLC entity may send the current corrected TX_HIGHEST pointer to the peer receiving AM RLC entity via this RLC control PDU (e.g., ARQ failure PDU). The TX_HIGHEST pointer may represent the highest SN number for which the RLC PDU have been transmitted by the transmitting AM RLC entity. Or the TX_HGHESET pointer may represent the SN number next to the highest one for which the RLC PDU have been transmitted by transmitting AM RLC entity. Examples ARQ failure PDU with 12-bit and 18-bit SN are shown in 1502 and 1504 of FIG. 15, respectively. In FIG. 15, the “D/C” field may be used to indicate whether this PDU is for data or control signaling. The “CPT” field may be used to indicate the control PDU type (e.g., the ARQ failure PDU here). The “TX_HIGHEST may be used to indicate the revised current RX_HIGHEST pointer of the active receiving window in the receiving AM RLC entity described above in relation to FIG. 5.

In some implementations, If the AM RLC entity which sends the RLC status report receives the ARQ failure PDU from its peer transmitting AM RLC entity, the receiving AM RLC entity may be configured to perform several steps. For example, If TX_HIGHEST indicated by the received ARQ failure PDU is less than the current RX_HIGHEST in the status report, the actual RX_HIGHEST pointer at the receiving RLC may be updated to the highest SN of the RLC SDU with SN less than or equal to the TX_HIGHEST and all segments of the RLC SDU are considered not received. The receiving RLC may further trigger to indicate the status report using the updated RX_HIGHEST pointer and/or further stop the t-StatusProhibit which is a timer used for preventing the AM RLC entity from frequent triggering of status report.

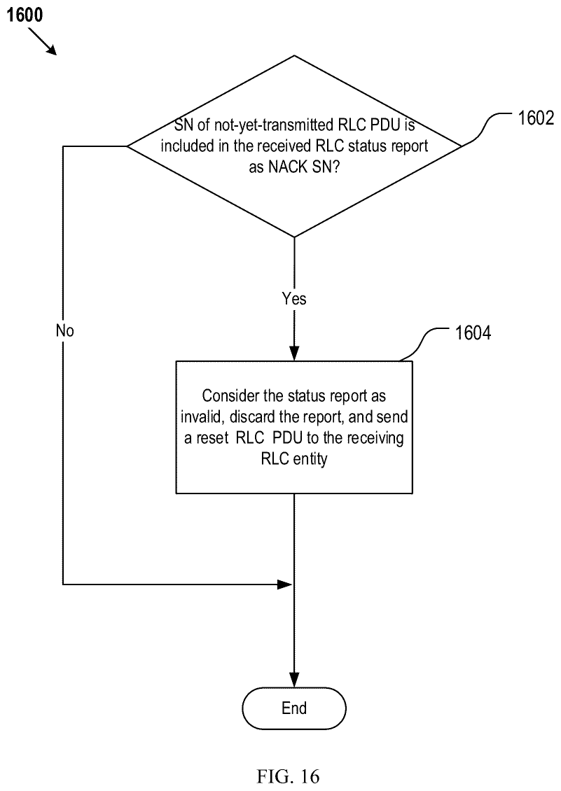

Another example processing flow at the transmitting device is illustrates by 1600 of FIG. 16. At 1602, similar to 1402 of FIG. 4, the transmitting device determines whether an SN of not-yet transmitted RLC PDU is included the received RLC status report from the corresponding receiving device as NACK SN. In other words, the transmitting device determines whether the RLC status report is inconsistent with the transmission information known at the transmitting device. If there is no inconsistency not only for the status report but also for any other kinds of inconsistency, the process ends. Otherwise, the transmitting device considers the status report as invalid, may discard it and send an RLC control PDU to inform the peer receiving AM RLC entity about the inconsistency, as shown by 1604.

The RLC control PDU, as shown in 1604 of FIG. 6, may be a RESET PDU and may be sent to the receiving AM RLC entity by the transmitting AM RLC entity when detecting inconsistency in the RLC status report. the RESET PDU may be used to reset all protocol states, protocol variables and protocol timer of the receiving AM RLC entity in order to synchronize the two AM RLC entities. In some implementation, after receiving the RESET PDU, the receiving AM RLC entity may send a RESET ACK PDU to the peer transmitting AM RLC entity as an ACK to the received RESET PDU.

In some implementations, when sending the RESET PDU or receiving the RESET ACK PDU, the transmitting entity may perform at least one of:
1) Stop and Reset all Timers;
2) Reset all state variables to their initial value; and/or
3) Discard all RLC SDU, RLC SDU segments, and RLC PDUs, if any.

In some implementation, when sending the RESET ACK PDU or receiving the RESET PDU, the receiving AM RLC entity may do at least one of:
1) Stop and Reset all Timers;
2) Reset all state variables to their initial value; and/or
3) Discard all RLC SDU, RLC SDU segments, and RLC PDUs, if any

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by a wireless device, comprising:
receiving, from a wireless communication node, an uplink resource grant allocated for an automatic repeat request (ARQ) process associated with a current media access control (MAC) protocol data unit (PDU) saved in an ARQ buffer of the ARQ process;
retrieving a new data indicator (NDI) associated with the ARQ process;
determining a resource size of the uplink resource grant; and
determining whether to ignore the uplink resource grant, flush the ARQ buffer, or replace the ARQ buffer with a new MAC PDU in response to receiving the uplink resource grant based on the NDI and/or a comparison between the resource size and a PDU size of the current MAC PDU saved in the ARQ buffer.

2. The method of claim 1, wherein determining whether to ignore the uplink resource grant, flush the ARQ buffer, or replace the ARQ buffer with a new MAC PDU in response to receiving the uplink resource grant comprises at least one of:
in response to determining that the NDI is toggled, replacing the current MAC PDU in the ARQ buffer with a new MAC PDU and transmitting the new MAC PDU using the received uplink resource grant,
in response to determining that the NDI is not toggled and determining that the resource size of the uplink resource grant matches the size of the current MAC PDU saved in the ARQ buffer, retransmitting the current MAC PDU saved in the ARQ buffer; and
in response to determining that the NDI is not toggled and determining that the resource size of the uplink resource grant does not match the size of the current MAC PDU saved in the ARQ buffer, discarding the uplink resource grant and/or flushing the ARQ buffer, or replacing the current MAC PDU in the ARQ buffer with a new MAC PDU and transmitting the new MAC PDU using the received uplink resource grant.

3. A method performed by a wireless device, comprising:
transmitting a current MAC PDU to a wireless communication network node; and
using an ARQ timer associated with an ARQ process corresponding to the transmitted current MAC PDU to control retransmission of the current MAC PDU.

4. The method of claim 3, wherein:
the ARQ timer comprises a buffer flush timer for an ARQ buffer of the ARQ process; and
using the ARQ timer to control the retransmission of the current MAC PDU comprises:
starting or restarting the buffer flush timer when the last symbol of the current MAC PDU is transmitted; and
in response to an expiration of the buffer flush timer, flushing the ARQ buffer.

5. The method of claim 3, wherein
the ARQ timer comprises an ARQ retransmission timer; and
using the ARQ timer to control the retransmission of the current MAC PDU comprises in response to determining that an uplink resource grant for the ARQ process associated with the current MAC PDU is received from the wireless communication network node:
determining whether the ARQ retransmission timer is configured and running; and
in response to determining that the ARQ retransmission timer is configured and running, determining whether to retransmit the current MAC PDU or transmit a new MAC PDU using the uplink resource grant, and
in response to determining that the ARQ retransmission timer is configured but not running, using the uplink resource grant to transmit the new MAC PDU regardless of a value of the NDI.

6. The method of claim 5, wherein determining whether to retransmit the current MAC PDU or transmit a new MAC PDU using the uplink resource grant comprises:
in response to an NDI of the ARQ process being toggled, using the uplink resource grant to transmit the new MAC PDU; and
in response to the NDI of the ARQ process not being toggled, using the uplink resource grant to retransmit the current MAC PDU.

7. A method performed by a wireless device, comprising:
configuring at least one ARQ process for retransmission of MAC PDUs associated with a serving cell for the wireless device serviced by a wireless network node;
receiving an ARQ control message from the wireless network node; and
controlling the at least one ARQ process according the ARQ control message.

8. The method of claim 7, wherein the ARQ control message comprises a MAC control element (CE) or a downlink control information (DCI) message.

9. The method of claim 7, wherein:
the ARQ control message comprises an ARQ buffer flush MAC CE or DCI for one or more of the at least one ARQ process associated with the serving cell; and
controlling the at least one ARQ process according the ARQ control message comprises flushing ARQ buffer for the one or more of the at least one ARQ process in response to receiving the ARQ control message.

10. The method of claim 9, wherein the ARQ control message comprises an ARQ buffer flush MAC CE, the ARQ buffer flush MAC CE comprising an ID for the serving cell and one or more flushing indicator fields corresponding to one or more ARQ process IDs.

11. The method of claim 8, wherein
the ARQ control message comprises an ARQ synchronization MAC CE or DCI for an ARQ process of the at least one ARQ process associated with the serving cell; and
the method further comprises configuring an NDI value of the ARQ process according an NDI indication included in the ARQ control message.

12. The method of claim 11, wherein the ARQ control message comprises the ARQ synchronization MAC CE, the ARQ synchronization MAC CE comprising an ID of the serving cell or a plurality of indicator fields for indicating ARQ process IDs for NDI value configuration or the ARQ synchronization MAC CE comprising a plurality of indicator fields for indicating serving cells for NDI value configuration.

13. The method of claim 7, wherein
the ARQ control message comprises an ARQ synchronization MAC CE or DCI for the at least one ARQ process associated with the serving cell; and
configuring an NDI value of the at least one ARQ process according an NDI indication included in the ARQ control message.

14. A wireless device comprising a processor and a memory, wherein the processor is configured to read computer code from the memory to implement a method in claim 1.

15. A computer program product comprising a non-transitory computer-readable program medium with computer code stored thereupon, the computer code, when executed by a processor, causing the processor to implement a method of claim 1.

16. A wireless device comprising a processor and a memory, wherein the processor is configured to read computer code from the memory to implement a method in claim 3.

17. A wireless device comprising a processor and a memory, wherein the processor is configured to read computer code from the memory to implement a method in claim 7.

18. A computer program product comprising a non-transitory computer-readable program medium with computer code stored thereupon, the computer code, when executed by a processor, causing the processor to implement a method of claim 3.

19. A computer program product comprising a non-transitory computer-readable program medium with computer code stored thereupon, the computer code, when executed by a processor, causing the processor to implement a method of claim 7.
